(19) United States
(12) Patent Application Publication
(10) Pub. No.: US 2019/0241078 A1
(43) Pub. Date: Aug. 8, 2019

(54) SHIFT CONTROL APPARATUS

(71) Applicant: Toyota Jidosha Kabushiki Kaisha, Toyota-shi (JP)

(72) Inventor: Yuta Tsubuki, Toyota-shi (JP)

(73) Assignee: TOYOTA JIDOSHA KABUSHIKI KAISHA, Toyota-shi (JP)

(21) Appl. No.: 16/263,001

(22) Filed: Jan. 31, 2019

(30) Foreign Application Priority Data
Feb. 7, 2018 (JP) 2018-020272

(51) Int. Cl. B60L 15/20; B60W 30/18; B60W 10/11; B60W 30/19

(52) U.S. Cl. CPC B60L 15/2054; B60L 15/2009; B60L 2240/423; B60W 10/11; B60W 30/19; B60W 30/18127

(57) ABSTRACT

A shift control unit is configured to permit the shifting of an automatic transmission when a rotational speed of a motor-generator after the lapse of a predetermined time is predicted to be equal to or higher than an engagement permissible rotational speed for a clutch and a required deceleration after the lapse of the predetermined time is predicted to be larger than a realizable deceleration after the lapse of the predetermined time by a predetermined threshold or more, and otherwise restrict the shifting of the automatic transmission during regenerative braking through the use of the motor-generator.

### INCORPORATION BY REFERENCE

The disclosure of Japanese Patent Application No. 2018-020272 filed on Feb. 7, 2018 including the specification, drawings and abstract is incorporated herein by reference in its entirety.

### BACKGROUND

### 1. Technical Field

The disclosure relates to a shift control apparatus.

### 2. Description of Related Art

It is described in Japanese Patent Application Publication No. 7-264711 (JP 7-264711 A) that the drop in braking force and the occurrence of a shock, which result from the suspension of regenerative braking, are suppressed by restricting the shifting of an automatic transmission during regenerative braking, in an electric vehicle that is equipped with a motor, the automatic transmission, and regenerative braking control means.

### SUMMARY

There is a hybrid vehicle that is configured such that an engine and a motor-generator are connected to each other via a K0 clutch and that an automatic transmission is provided between a motive power source and driving wheels. In the hybrid vehicle according to this configuration as well, it is conceivable to restrict the shifting of the automatic transmission during regenerative braking, with a view to suppressing the drop in braking force and the occurrence of a shock, which result from the suspension of regenerative braking.

However, in the case where the speed of the vehicle increases to such an extent that a required deceleration cannot be realized through regenerative braking by the motor alone when the vehicle coasts on a downward slope with the K0 clutch released, engine braking needs to be additionally used by engaging the K0 clutch again. In the case where the shifting during regenerative braking is restricted, shifting is carried out immediately before the K0 clutch is engaged again, so it takes long before engine braking begins to take effect. As a result, it takes long before the required deceleration is approached, and a deterioration in drivability is caused.

The disclosure provides a shift control apparatus that can control an automatic transmission such that engine braking can be operated with good response in case of necessity, and that can suppress the drop in braking force, the occurrence of a shock, and the decrease in regeneration efficiency during regenerative braking.

An aspect of the disclosure relates to a shift control apparatus configured to control the shifting of an automatic transmission in a hybrid vehicle having an engine, the motor-generator, a clutch and the automatic transmission, the automatic transmission being connected to the motor-generator, the clutch being interposed between the engine and the motor-generator. The shift control apparatus is equipped with a rotational speed prediction unit configured to predict a rotational speed of the motor-generator after the lapse of a predetermined time, in a state that the clutch detached and that the hybrid vehicle coasting, a required deceleration prediction unit configured to predict a required deceleration that is required for the braking of the hybrid vehicle after the lapse of the predetermined time, a realizable deceleration prediction unit configured to predict a realizable deceleration that can be realized through regeneration by the motor-generator after the lapse of the predetermined time to brake the hybrid vehicle, and a shift control unit configured to control the shifting of the automatic transmission. The shift control unit is configured to permit the shifting of the automatic transmission when the predicted rotational speed of the motor-generator is equal to or higher than an engagement permissible rotational speed for the clutch and the predicted required deceleration is larger than the predicted realizable deceleration by a predetermined threshold or more, and otherwise restrict the shifting of the automatic transmission during regenerative braking through the use of the motor-generator.

According to the aforementioned aspect, the shifting of the automatic transmission is controlled when the vehicle coasts with the clutch between the engine and the motor-generator released and regenerative braking is carried out by the motor-generator. When the rotational speed of the motor-generator after the lapse of the predetermined time is equal to or higher than the engagement permissible rotational speed for the clutch and the required deceleration after the lapse of the predetermined time is larger than the realizable deceleration by the predetermined threshold or more, the shifting of the automatic transmission is permitted even during regenerative braking, and the response of engine braking is thereby enhanced. When the aforementioned conditions are not fulfilled, the shifting of the automatic transmission during regenerative braking is restricted to suppress the drop in braking force and the occurrence of a shock, which result from the suspension of regenerative braking, and the regeneration efficiency is thereby enhanced.

In the aforementioned aspect, the rotational speed prediction unit and the required deceleration prediction unit may be configured to predict the rotational speed of the motor-generator after the lapse of the predetermined time and the required deceleration after the lapse of the predetermined time respectively, based on slope information included in map information.

According to the aforementioned configuration, the accuracy in predicting the required deceleration can be enhanced by predicting the vehicle speed after the lapse of the predetermined time based on the slope information included in the map information, and predicting the rotational speed and the required deceleration after the lapse of T seconds through the use of the predicted vehicle speed after the lapse of the predetermined time. Therefore, more accurate shift control is made possible.

According to the aforementioned aspect, it is possible to provide a shift control apparatus that can control an automatic transmission such that engine braking can be operated with good response in case of necessity, and that can suppress the drop in braking force, the occurrence of a shock, and the decrease in regeneration efficiency during regenerative braking.

### BRIEF DESCRIPTION OF THE DRAWINGS

Features, advantages, and technical and industrial significance of an exemplary embodiment of the disclosure will be described below with reference to the accompanying drawings, in which like numerals denote like elements, and wherein:

FIG. 1 is a functional block diagram showing the overall configuration of a hybrid vehicle that is mounted with a shift control apparatus according to the embodiment;

FIG. 2 is a functional block diagram of the shift control apparatus shown in FIG. 1;

FIG. 3 is a view for illustrating an exemplary method of predicting a required deceleration and an MG realizable deceleration after the lapse of T seconds;

FIG. 4 is a view for illustrating an exemplary method of predicting a rotational speed of a motor-generator after the lapse of T seconds;

FIG. 5 is a flowchart showing a control process of the shift control apparatus according to the embodiment;

FIG. 6 is a time chart showing an example of control of an automatic transmission according to a comparative example;

FIG. 7A is a time chart showing an example of control of an automatic transmission that is performed by the shift control apparatus according to the embodiment;

FIG. 7B is a time chart showing another example of control of the automatic transmission that is performed by the shift control apparatus according to the embodiment; and

FIG. 7C is a time chart showing still another example of control of the automatic transmission that is performed by the shift control apparatus according to the embodiment.

### DETAILED DESCRIPTION OF EMBODIMENT

(Outline) In the disclosure, while regenerative braking is carried out in a state where a vehicle coasts with a clutch between an engine and a motor-generator detached, the shifting of an automatic transmission is restricted in principle, so as to suppress the drop in braking force and the occurrence of a shock, which result from the suspension of regenerative braking. It should be noted, however, that when a rotational speed of the motor-generator after the lapse of T seconds is predicted to be equal to or higher than an engagement permissible rotational speed for the clutch and a required deceleration after the lapse of T seconds is predicted to be larger than a realizable deceleration after the lapse of T seconds by a predetermined threshold or more, the shifting of the automatic transmission is permitted even during regenerative braking, so as to enhance the response of engine braking.

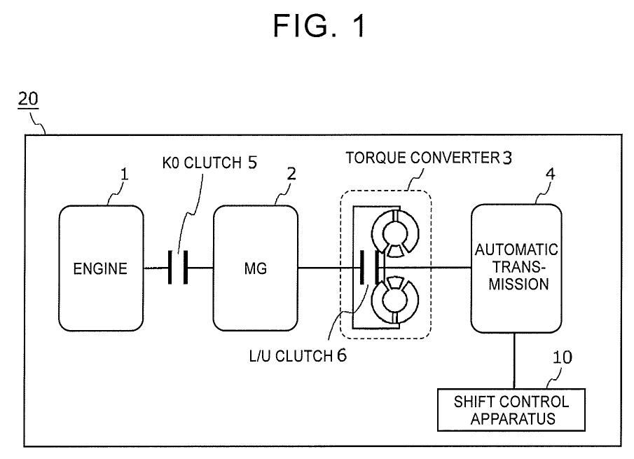

### First Embodiment

[symbol] Configuration [symbol] FIG. 1 is a functional block diagram showing the overall configuration of a hybrid vehicle that is mounted with a shift control apparatus according to the first embodiment.

A vehicle 20 is a hybrid vehicle that is equipped with an engine 1, a motor-generator (an MG) 2 that functions as a motor for running and a generator, a torque converter 3, a stepped automatic transmission 4, and a shift control apparatus 10. The engine 1 and the motor-generator 2 are detachably connected to each other via a K0 clutch 5. Outputs of the engine 1 and the motor-generator 2 are transmitted to the automatic transmission 4 via the torque converter 3, and are transmitted to right and left driving wheels via an output shaft (not shown), a differential gear device (not shown), and the like. The torque converter 3 has a lockup clutch (an L/U clutch) 6 that directly couples a pump impeller and a turbine impeller to each other.

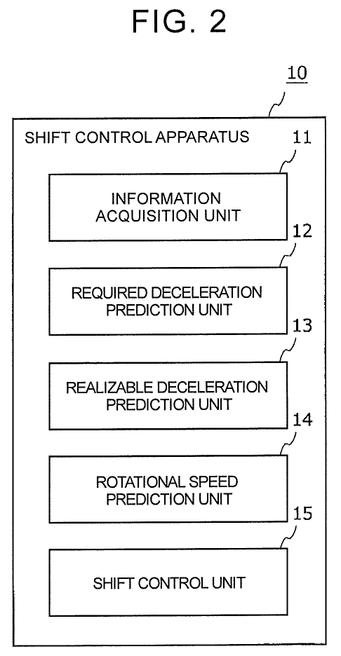

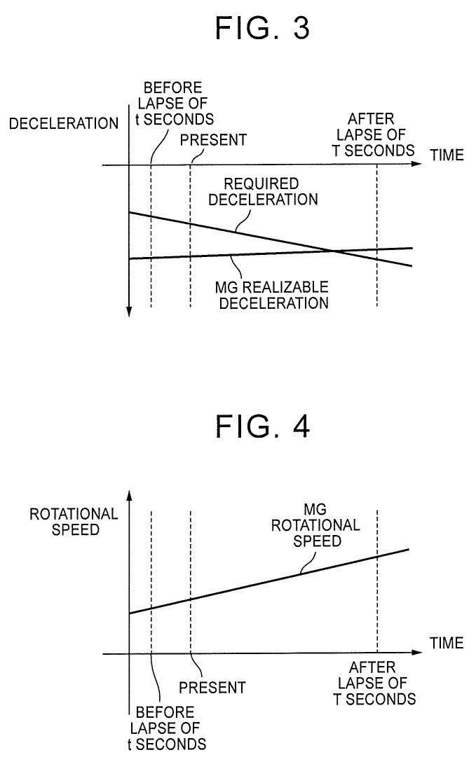

FIG. 2 is a functional block diagram of the shift control apparatus shown in FIG. 1. Besides, FIG. 3 is a view for illustrating an exemplary method of predicting a required deceleration and an MG realizable deceleration after the lapse of T seconds, and FIG. 4 is a view for illustrating an exemplary method of predicting a rotational speed of the motor-generator after the lapse of T seconds.

The shift control apparatus 10 is equipped with an information acquisition unit 11 that acquires various pieces of information on a running state of the vehicle, a required deceleration prediction unit 12 that predicts a required deceleration after the lapse of T seconds, a realizable deceleration prediction unit 13 that predicts an MG realizable deceleration after the lapse of T seconds, which can be realized by regenerative braking through the use of the motor-generator, a rotational speed prediction unit 14 that predicts a rotational speed of the motor-generator after the lapse of T seconds, and a shift control unit 15 that controls the shifting of the automatic transmission.

The information acquisition unit 11 acquires and stores various pieces of information that are needed to control the shifting of the automatic transmission, such as the rotational speed of the motor-generator, the rotational speed of the engine, the rotational speed of the output shaft, a vehicle speed, a remaining battery level (an SOC value), and the like. In the present embodiment, the vehicle speed and the remaining battery level, which have been acquired by the information acquisition unit 11, are used to predict the required deceleration after the lapse of T seconds, the MG realizable deceleration after the lapse of T seconds, and the rotational speed of the motor-generator after the lapse of T seconds. The information acquisition unit 11 periodically acquires the vehicle speed and the remaining battery level, and stores the information acquired during a certain period in the past.

The required deceleration prediction unit 12 predicts the required deceleration after the lapse of T seconds, based on data on the vehicle speed acquired during the certain period in the past by the information acquisition unit 11. The required deceleration is a braking force or acceleration that is required for the braking of the vehicle, and is expressed in the present specification on the assumption that a braking direction (a backward direction with respect to the vehicle) is a positive direction. When the vehicle coasts on a downward slope with the K0 clutch released, the magnitude of the required deceleration increases as the vehicle speed increases.

As shown in FIG. 3, the required deceleration prediction unit 12 predicts a required deceleration G_{reqT} after the lapse of T seconds, through linear interpolation, from a required deceleration before the lapse of t seconds and a current required deceleration. A required deceleration G_{req} during coasting is expressed as a function of a vehicle speed v as indicated by an equation 1 shown below.

G_{req}=X(v) [Equation 1]

It should be noted herein that an amount Δv of change in vehicle speed during t seconds is expressed by an equation 2 shown below, when v₀ denotes a vehicle speed before the lapse of t seconds and v₁ denotes a current vehicle speed. Incidentally, the vehicle speeds v₀ and v₁ are data acquired by the information acquisition unit 11.

Δv=v₁−v₀ [Equation 2]

If it is assumed, with a view to carrying out linear interpolation, that the amount Δv of change in vehicle speed is constant during the predetermined T seconds, the required deceleration G_{reqT} after the lapse of T seconds can be calculated according to an equation 3 shown below.

G_{reqT}=X(v₁−Δv*T/t) [Equation 3]

The realizable deceleration prediction unit 13 predicts an MG realizable deceleration after the lapse of T seconds, based on the data on the remaining battery level acquired during the certain period in the past by the information acquisition unit 11. The MG realizable deceleration is a braking force or acceleration that can be realized through regeneration by the motor-generator to brake the hybrid vehicle, and is expressed in the present specification on the assumption that the braking direction (the backward direction with respect to the vehicle) is the positive direction. As is the case with the required deceleration, the MG realizable deceleration after the lapse of T seconds can be predicted through linear interpolation from the MG realizable deceleration before the lapse of t seconds and the current MG realizable deceleration (see FIG. 3). A realizable deceleration Gᵣₑₐₗ of the motor-generator is expressed as a function of a remaining battery level c (%) as indicated by an equation 4 shown below.

Gᵣₑₐₗ=Y(c) [Equation 4]

It should be noted herein that an amount Δc of change in remaining battery level during t seconds is expressed by an equation 5 shown below, when c₀ denotes a remaining battery level before the lapse of t seconds and c₁ denotes a current remaining battery level. Incidentally, the remaining battery levels c₀ and c₁ are data acquired by the information acquisition unit 11.

Δc=c₁−c₀ [Equation 5]

If it is assumed, with a view to carrying out linear interpolation, that the amount Δc of change in remaining battery level is constant during the predetermined T seconds, an MG realizable deceleration G_{realT} after the lapse of T seconds can be calculated according to an equation 6 shown below.

G_{realT}=Y(c₁+Δc*T/t) [Equation 6]

The rotational speed prediction unit 14 predicts a rotational speed of the motor-generator after the lapse of T seconds, based on the data on the vehicle speed acquired during the certain period in the past by the information acquisition unit 11. This predicted rotational speed of the motor-generator is a rotational speed in the case where the vehicle coasts with the K0 clutch released. When the vehicle coasts on a downward slope with the K0 clutch released, the rotational speed of the motor-generator also increases as the vehicle speed increases. When the K0 clutch is engaged again with the rotational speed of the motor-generator equal to or higher than an engagement permissible rotational speed for the K0 clutch, a malfunction such as seizure or the like of the K0 clutch may be caused. Thus, the rotational speed of the motor-generator after the lapse of T seconds, which has been predicted by the rotational speed prediction unit 14, is used to determine whether or not the K0 clutch can be engaged again after the lapse of T seconds.

A rotational speed N of the motor-generator is expressed as a function of the vehicle speed v as indicated by an equation 7 shown below.

N=Z(v) [Equation 7]

Besides, the amount Δv of change in vehicle speed during t seconds is expressed by the above-mentioned equation 2. If it is assumed, with a view to carrying out linear interpolation, that the amount Δv of change in vehicle speed is constant during the predetermined T seconds, a rotational speed N_{T} of the motor-generator after the lapse of T seconds can be calculated according to an equation 8 shown below.

N_{T}=Z(v₁+Δv*T/t) [Equation 8]

Incidentally, the method of predicting the required deceleration, the MG realizable deceleration, and the rotational speed of the motor-generator after the lapse of T seconds as exemplified herein is an example. These predicted values may be calculated by solving an equation of motion, or using a map created from experimental data or the like.

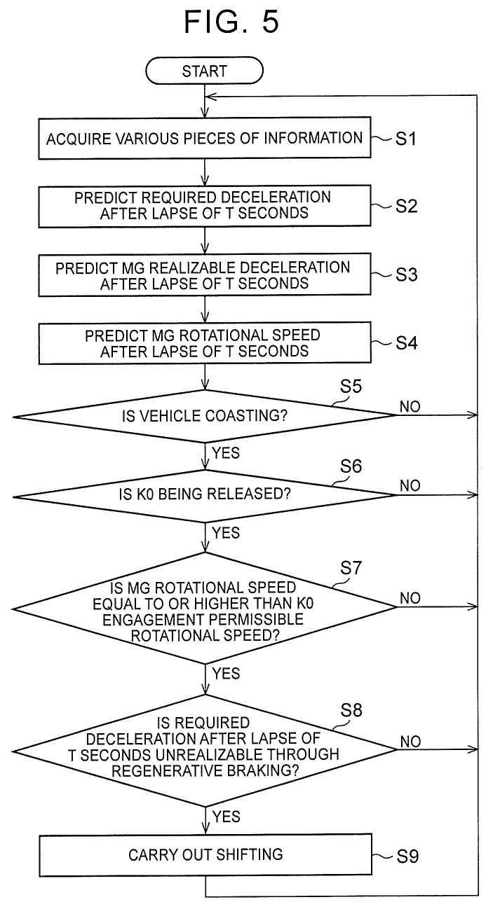

The shift control unit 15 controls the shifting of the automatic transmission based on the required deceleration after the lapse of T seconds, which has been predicted by the required deceleration prediction unit 12, the MG realizable deceleration after the lapse of T seconds, which has been predicted by the realizable deceleration prediction unit 13, and the rotational speed of the motor-generator after the lapse of T seconds, which has been predicted by the rotational speed prediction unit 14. The shift control unit 15 restricts the shifting of the automatic transmission in principle, during regenerative braking through the use of the motor-generator. It should be noted, however, that the shifting of the automatic transmission is carried out even during regenerative braking, when conditions (1) and (2) shown below are simultaneously fulfilled. The condition (1) is that the predicted rotational speed of the motor-generator after the lapse of T seconds is equal to or higher than the engagement permissible rotational speed for the K0 clutch. The condition (2) is that the predicted required deceleration after the lapse of T seconds is larger than the predicted MG realizable deceleration after the lapse of T seconds by a predetermined threshold or more.

[symbol] Control Process [symbol] FIG. 5 is a flowchart showing a control process of the shift control apparatus according to the embodiment. The control process of the shift control apparatus 10 will be described hereinafter with comprehensive reference to FIGS. 2 and 5.

In step S1, the information acquisition unit 11 acquires various pieces of information that are needed to control the shifting of the automatic transmission. After that, the process proceeds to step S2.

In step S2, the required deceleration prediction unit 12 predicts a required deceleration after the lapse of T seconds, based on information acquired during a certain period in the past by the information acquisition unit 11. After that, the process proceeds to step S3.

In step S3, the realizable deceleration prediction unit 13 predicts an MG realizable deceleration that can be realized by regenerative braking through the use of the motor-generator after the lapse of T seconds, based on the information acquired during the certain period in the past by the information acquisition unit 11. After that, the process proceeds to step S4.

In step S4, the rotational speed prediction unit 14 predicts a rotational speed of the motor-generator after the lapse of T seconds, based on the information acquired during the certain period in the past by the information acquisition unit 11. After that, the process proceeds to step S5.

In step S5, the shift control unit 15 determines whether or not the vehicle is coasting. It can be determined that the vehicle is coasting, when neither an accelerator nor a brake has been depressed. If YES in step S5, the process proceeds to step S6. Otherwise, the process returns to step S1.

In step S6, the shift control unit 15 determines whether or not the K0 clutch is being released. If YES in step S6, the process proceeds to step S7. Otherwise, the process returns to step S1.

In step S7, the shift control unit 15 determines whether or not the rotational speed of the motor-generator after the lapse of T seconds as predicted in step S4 is equal to or higher than the engagement permissible rotational speed for the K0 clutch. If the determination in step S7 is YES, the process proceeds to step S8. Otherwise, the process returns to step S1.

In step S8, the shift control unit 15 determines whether or not the required deceleration after the lapse of T seconds as predicted in step S2 is unrealizable through regenerative braking by the motor-generator. More specifically, the shift control unit 15 determines whether or not the required deceleration after the lapse of T seconds as predicted in step S2 is larger than the MG realizable deceleration after the lapse of T seconds as predicted in step S3, by the predetermined threshold or more. If the determination in step S8 is YES, the process proceeds to step S9. Otherwise, the process returns to step S1.

In step S9, the shift control unit 15 raises the gear stage by one or more stages by carrying out the shifting of the automatic transmission. After that, the process returns to step S1, and the above-mentioned process is repeatedly performed during the running of the vehicle.

An advantage of a method of controlling the automatic transmission according to the present embodiment will be described hereinafter while making a comparison with a comparative example.

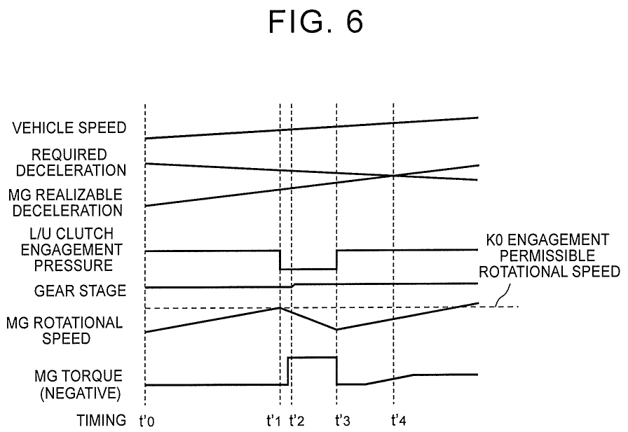

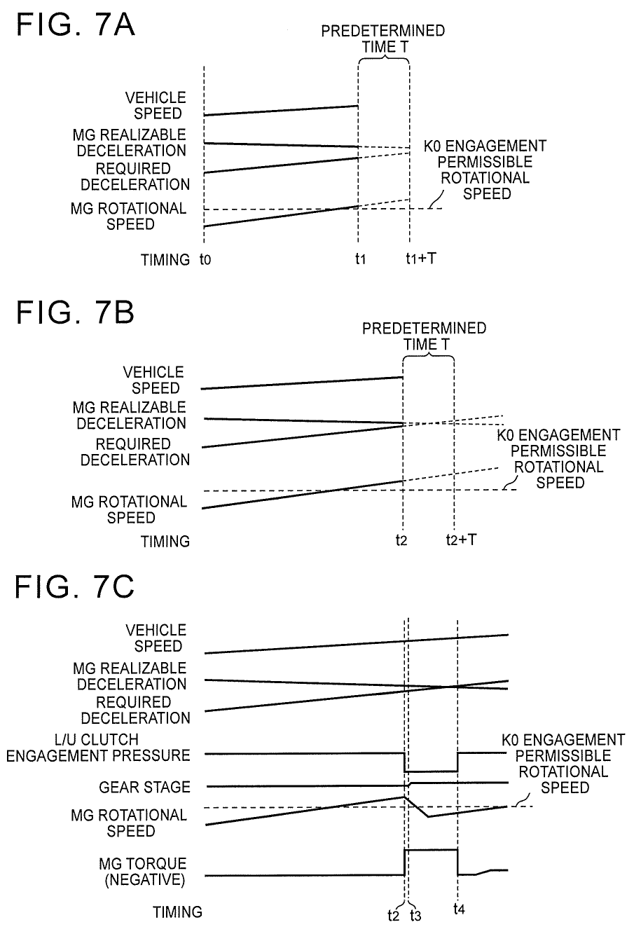

FIG. 6 is a time chart showing an example of control of an automatic transmission according to the comparative example. Each of FIGS. 7A, 7B, and 7C is a time chart showing an example of control of the automatic transmission that is performed by the shift control apparatus according to the embodiment.

First of all, the example of shift control of the automatic transmission according to the comparative example will be described with reference to FIG. 6. In the comparative example shown in FIG. 6, the control of raising the gear stage by one stage is performed by carrying out the shifting of the automatic transmission as soon as the rotational speed of the motor-generator becomes equal to or higher than the engagement permissible rotational speed for the K0 clutch.

When the vehicle runs on a downward slope with a relatively large gradient through coasting with the K0 clutch released, the required deceleration of the vehicle also increases as the vehicle speed increases. On the other hand, when the vehicle is decelerated by regenerative braking through the use of the motor-generator, the regeneratable electric power drops as the remaining battery level increases, so the MG realizable deceleration drops. Besides, the rotational speed of the motor-generator also increases as the vehicle speed increases (in a period from a timing t′₀ to a timing t′₁ in FIG. 6).

When the rotational speed of the motor-generator becomes equal to or higher than the engagement permissible rotational speed for the K0 clutch at the timing t′₁, the shift control apparatus lowers the engagement pressure of the L/U clutch to lower the torque of the motor-generator. The torque of the motor-generator is lowered so as to reduce the shock resulting from shifting. After that, the shift control apparatus carries out the shifting of the automatic transmission at a timing t′₂, and then raises the engagement pressure of the L/U clutch to raise the torque of the motor-generator again at a timing t′₃.

It is assumed herein that the required deceleration becomes smaller than the MG realizable deceleration after a timing t′₄ due to a further increase in vehicle speed. When it becomes impossible to realize the required deceleration by regenerative braking through the use of the motor-generator alone, it becomes necessary to combine regenerative braking with engine braking. In the comparative example shown in FIG. 6, the shifting of the automatic transmission is carried out in advance at the timing t′₂, as soon as the rotational speed of the motor-generator becomes equal to or higher than the engagement permissible rotational speed for the K0 clutch. Shifting is carried out such that the rotational speed of the motor-generator becomes lower than the engagement permissible rotational speed for the K0 clutch. Therefore, even when it becomes necessary to use engine braking after the timing t′₄, a braking force resulting from engine braking can be generated with good response by engaging the K0 clutch again. Accordingly, an improvement in drivability is considered to be possible.

However, during the actual running of the vehicle, the required deceleration of the vehicle may change to such an extent as to be realizable through regenerative braking by the motor-generator alone due to gradual decreases in downward gradient of a running road or the flattening of the running road after shifting is carried out at the timing t′₂ in FIG. 6. In this case, it is unnecessary to brake the vehicle through engine braking after shifting is carried out. The comparative example shown in FIG. 6 is advantageous in that the K0 clutch is prevented from malfunctioning, and that the response of engine braking is improved. However, if the shifting during regenerative braking is permitted even in the case where it becomes unnecessary to brake the vehicle through engine braking after shifting is carried out, a drop in braking force and the occurrence of a shock during regenerative braking are inevitable. Besides, when shifting is carried out during regenerative braking, there is also a problem of a decrease in regeneration efficiency as a result of the suspension of regenerative braking or a drop in torque of the motor-generator. Accordingly, there is room for improvement in shift control for uniformly carrying out shifting based on a comparison between the rotational speed of the motor-generator and the engagement permissible rotational speed for the K0 clutch.

Next, an example of shift control of the automatic transmission according to the present embodiment will be described with comprehensive reference to FIGS. 2, 7A, 7B, and 7C. In each of FIGS. 7A and 7B, broken lines indicating the MG realizable deceleration, the required deceleration, and the MG rotational speed represent parts predicted through linear interpolation. As described above, the shift control unit 15 of the shift control apparatus 10 according to the present embodiment determines whether or not shifting can be carried out during regenerative braking, based on predicted values of the required deceleration after the lapse of T seconds, the MG realizable deceleration after the lapse of T seconds, and the rotational speed of the motor-generator after the lapse of T seconds.

As shown in FIG. 7A, when the vehicle runs on a downward slope with a relatively large gradient through coasting with the K0 clutch released, the required deceleration of the vehicle also increases as the vehicle speed increases. On the other hand, when the vehicle is decelerated by regenerative braking through the use of the motor-generator, the regeneratable electric power drops as the remaining battery level increases. Therefore, the MG realizable deceleration drops. Besides, the rotational speed of the motor-generator also increases as the vehicle speed increases (in a period from a timing t₀ to a timing t₁ in FIG. 7A).

At the timing t₁ in FIG. 7A, the rotational speed of the motor-generator becomes equal to or higher than the engagement permissible rotational speed for the K0 clutch, but the MG realizable deceleration after the lapse of T seconds as predicted at the timing t₁ is larger than the required deceleration after the lapse of T seconds as predicted at the timing t₁. Accordingly, at the stage of the timing t₁, the shift control unit 15 does not carry out shifting.

Subsequently, at a timing t₂ in FIG. 7B, the required deceleration prediction unit 12, the realizable deceleration prediction unit 13, and the rotational speed prediction unit 14 predict the required deceleration, the MG realizable deceleration, and the rotational speed of the motor-generator after the lapse of T seconds, respectively. As a result of the prediction, the shift control unit 15 determines that the required deceleration after the lapse of T seconds as predicted at the timing t₂ is larger than the MG realizable deceleration after the lapse of T seconds by the predetermined threshold or more, and that the rotational speed of the motor-generator after the lapse of T seconds as predicted at the timing t₂ is equal to or higher than the engagement permissible rotational speed for the K0 clutch. In this case, with a view to carrying out shifting, the shift control unit 15 lowers the engagement pressure of the L/U clutch to lower the torque of the motor-generator at the timing t₂. As described above, the torque of the motor-generator is lowered so as to reduce the shift shock. After that, as shown in FIG. 7C, the shift control unit 15 carries out the shifting of the automatic transmission at a timing t₃, and then raises the engagement pressure of the L/U clutch to raise the torque of the motor-generator again at a timing t₄.

It is assumed herein that the required deceleration increases due to a further increase in vehicle speed after the timing t₄. When it becomes impossible to realize the required deceleration through regenerative braking by the motor-generator alone, it becomes necessary to combine regenerative braking with engine braking. In the example shown in FIG. 7C, the shift control unit 15 permits the shifting of the automatic transmission in advance based on the predicted values after the lapse of T seconds at the stage of the timing t₂, and carries out shifting at the timing t₃. By carrying out shifting, the rotational speed of the motor-generator becomes lower than the engagement permissible rotational speed for the K0 clutch. Therefore, when it becomes necessary to use engine braking after the timing t₄, a braking force resulting from engine braking can be generated with good response, by engaging the K0 clutch again. Accordingly, an improvement in drivability can be made.

On the other hand, as described in the comparative example of FIG. 6, during the actual running of the vehicle, the magnitude of the required deceleration of the vehicle may change to such an extent as to be realizable through regenerative braking by the motor-generator alone due to gradual decreases in downward gradient of a running road or the flattening of the running road after shifting is carried out. However, in shift control according to the present embodiment, a determination on the necessity to carry out shifting is made based on the predicted values of the required deceleration and the MG realizable deceleration after the lapse of T seconds. Therefore, in the case where the required deceleration drops, the gear stage can be maintained without carrying out shifting.

[symbol] Effect and the Like [symbol] As described above, in the case where the vehicle coasts with the K0 clutch released and regenerative braking is carried out by the motor-generator, the shift control apparatus 10 according to the present embodiment carries out the shifting of the automatic transmission when the rotational speed of the motor-generator after the lapse of T seconds is predicted to be equal to or higher than the engagement permissible rotational speed for the clutch and the required deceleration after the lapse of T seconds is predicted to be larger than the MG realizable deceleration after the lapse of T seconds by the predetermined threshold or more. Then, when these conditions are not fulfilled, the shift control apparatus according to the present embodiment restricts the shifting during regenerative braking. In the case where the required deceleration is predicted to be unrealizable through regenerative braking by the motor-generator, an improvement in drivability can be made through the betterment of response at the time when engine braking is necessitated, by carrying out shifting in advance. Besides, in the case where the required deceleration may be realizable through regenerative braking by the motor-generator, the drop in braking force and the occurrence of a shock during regenerative braking can be suppressed, and the regeneration efficiency can also be enhanced, by restricting the shifting during regenerative braking.

### OTHER MODIFICATION EXAMPLES

In the shift control apparatus according to the above-mentioned embodiment, the vehicle speed after the lapse of T seconds may be predicted with the aid of map information retained by a navigation system, and sensors with which the vehicle is equipped.

In the case where the map information is utilized to predict the vehicle speed, the information acquisition unit 11 shown in FIG. 2 acquires information on the inclination of a running route from the map information in the navigation system, in step S1 shown in FIG. 5. Besides, in the case where the sensors with which the vehicle is equipped are utilized to predict the vehicle speed, the information acquisition unit 11 acquires information on the inclination such as the gradient, length and the like of each downward slope based on outputs of the various sensors of the vehicle. The required deceleration prediction unit 12 and the rotational speed prediction unit 14 predict the vehicle speed after the lapse of T seconds from the acquired information on the inclination, a current vehicle speed, and a mass of the vehicle, and predict the required deceleration after the lapse of T seconds and the rotational speed of the motor-generator after the lapse of T seconds, respectively, based on the predicted vehicle speed after the lapse of T seconds. An inclination angle sensor, a camera, an acceleration sensor, and the like can be utilized as the sensors with which the vehicle is equipped. Besides, the map information in the navigation system and the outputs of the sensors of the vehicle may be used in combination to predict the vehicle speed after the lapse of T seconds. The shift control apparatus according to each of the modification examples predicts the vehicle speed through the use of the map information and/or the outputs of the various sensors, and predicts the required deceleration through the use of the predicted vehicle speed after the lapse of T seconds. Accordingly, in addition to the effect described in the above-mentioned embodiment, the accuracy in predicting the required deceleration can be enhanced, so more accurate shift control is made possible.

What is claimed is:

1. A shift control apparatus configured to control shifting of an automatic transmission in a hybrid vehicle having an engine, a motor-generator, a clutch and the automatic transmission, the automatic transmission being connected to the motor-generator, the clutch being interposed between the engine and the motor-generator, the shift control apparatus comprising:
a rotational speed prediction unit configured to predict a rotational speed of the motor-generator after lapse of a predetermined time, in a state that the clutch detached and that the hybrid vehicle coasting;
a required deceleration prediction unit configured to predict a required deceleration that is required for braking of the hybrid vehicle after lapse of the predetermined time;
a realizable deceleration prediction unit configured to predict a realizable deceleration that can be realized through regeneration by the motor-generator after lapse of the predetermined time to brake the hybrid vehicle; and
a shift control unit configured to control shifting of the automatic transmission, wherein
the shift control unit is configured to
permit shifting of the automatic transmission when the predicted rotational speed of the motor-generator is equal to or higher than an engagement permissible rotational speed for the clutch and the predicted required deceleration is larger than the predicted realizable deceleration by a predetermined threshold or more, and
otherwise restrict shifting of the automatic transmission during regenerative braking through use of the motor-generator.

2. The shift control apparatus according to claim 1, wherein
the rotational speed prediction unit and the required deceleration prediction unit are configured to predict the rotational speed of the motor-generator after lapse of the predetermined time and the required deceleration after lapse of the predetermined time respectively, based on slope information included in map information.
